(19) United States
(12) Patent Application Publication
(10) Pub. No.: US 2016/0227483 A1
(43) Pub. Date: Aug. 4, 2016

(54) WIRELESS DEVICE AND METHOD

(71) Applicant: KAIBUSHIKI KAISHA TOSHIBA, Minato-ku, Tokyo (JP)

(72) Inventors: Stephen WANG, Bristol (GB); Konstantinos MIMIS, Bristol (GB); Justin COON, Bristol (GB)

(73) Assignee: Kabushiki Kaisha Toshiba, Tokyo (JP)

(21) Appl. No.: 15/022,758

(22) PCT Filed: Sep. 18, 2013
(86) PCT No.: PCT/GB2013/052439

§ 371 Date: Mar. 17, 2016

(51) Int. Cl. H04W 52/02; H04W 72/04; H04B 1/04

(52) U.S. Cl. CPC H04W 52/0245; H04B 1/0475; H04W 72/0453; H04B 2001/0416

(57) ABSTRACT

In an embodiment a wireless device comprises a plurality of power amplifiers operable to generate signals for transmission over different frequency channels of a wireless network; an antenna system coupled to the plurality of power amplifiers configured to transmit the signals generated by the power amplifiers; a battery configured to store energy and to supply electrical energy to the plurality of power amplifiers; an energy harvesting unit configured to harvest energy from the environment surrounding the wireless device and transfer the harvested energy to the battery; a management unit configured to determine spectrum status information of the wireless network, select one or more channels of the wireless network, and determine the output power of the power amplifiers; and a configuration unit configured to control the efficiency and output power of each of the power amplifiers.

### FIELD

Embodiments described herein relate generally to wireless devices. More particularly, embodiments relate to control of power amplifiers in wireless devices

### BACKGROUND

With the ever-increasing demand for ubiquitous information and communication technology (ICT) services, global greenhouse gas emissions from this sector are expected to increase dramatically in the near future. As a result, energy efficiency of future ICT services has been gaining interest.

The increasing aging population has led to a fast-growing ICT-related healthcare market. Medical body area networks (MBANs), along with associated standards, such as, IEEE 802.15.6, IEEE 802.15.4j and Bluetooth Low Energy (BT-LE), are attracting considerable attention due to the ICT services they can provide. In MBANs, widely-deployed portable devices and unlicensed operations make energy efficiency and opportunistic spectrum access an important field of research.

### BRIEF DESCRIPTION OF THE DRAWINGS

In the following embodiments will be described as non-limiting examples with reference to the accompanying drawings in which:

FIG. 1 shows a medical body area network according to an embodiment;

FIG. 2 shows a transmitter according to an embodiment;

FIG. 2a shows a transmitter according to an embodiment;

FIG. 3 shows a flow chart illustrating a method of controlling a power amplifier system according to an embodiment;

FIG. 4 shows a transmitter according to an embodiment;

FIG. 5 shows timing diagram of packet transmission in an embodiment;

FIG. 6 shows flow chart of a method of controlling a power amplifier system according to an embodiment;

FIG. 7a shows control of an amplifier configuration using load modulation in an embodiment;

FIG. 7b shows control of an amplifier configuration using load selection in an embodiment;

FIG. 7c shows control of an amplifier configuration using supply voltage selection in an embodiment;

FIG. 7d shows control of an amplifier configuration using output power aggregation and frequency agile transmission in an embodiment;

FIG. 8 shows the efficiency performance using load modulation in an embodiment;

FIG. 9 shows the efficiency performance using supply voltage selection in an embodiment; and

FIG. 10 shows the efficiency performance using the combination of load modulation and supply voltage selection in an embodiment.

### DETAILED DESCRIPTION

In an embodiment a wireless device comprises a plurality of power amplifiers operable to generate signals for transmission over different frequency channels of a wireless network; an antenna system coupled to the plurality of power amplifiers configured to transmit the signals generated by the power amplifiers; a battery configured to store energy and to supply electrical energy to the plurality of power amplifiers; an energy harvesting unit configured to harvest energy from the environment surrounding the wireless device and transfer the harvested energy to the battery; a management unit configured to determine spectrum status information of the wireless network, select one or more channels of the wireless network, and determine the output power of the power amplifiers; and a configuration unit configured to control the efficiency and output power of each of the power amplifiers.

In an embodiment the energy harvesting unit is configured to harvest radiofrequency energy using the antenna system and/or other non-radiofrequency energy.

In an embodiment the management unit is configured to determine the spectrum status information using the antenna system.

In an embodiment the management unit is configured to obtain the spectrum status information by connecting to a database using the antenna system.

In an embodiment the management unit is configured to obtain the spectrum status information by real time sensing using the antenna system.

In an embodiment the management unit is configured to determine spectrum status information conduct energy harvesting within a first time slot and to configure the configuration unit to control transmission of data within a second time slot.

In an embodiment the configuration unit is configured to control the power amplifier system to transmit a packet of data over a plurality of frames, each frame comprising a first time slot and a second time slot.

In an embodiment the management unit is configured determine if the device is moving and to download spectrum status information for a plurality of cells of the wireless network if the device is moving.

In an embodiment the configuration unit is configured to control the output power of the power amplifiers by controlling a supply voltage to the power amplifiers.

In an embodiment the configuration unit is configured to select the supply voltage from a voltage level for an inactive mode, a voltage level for a low power transmission mode and a voltage level for a high power transmission mode.

In an embodiment the configuration unit is configured to control a load of the power amplifiers.

In an embodiment the configuration unit is configured to select the load for the power amplifiers from a load bank depending on the output power level required.

In an embodiment the configuration unit is configured to control the power amplifiers and RF combiner/router to aggregate the output power of at least two of the power amplifiers.

In an embodiment the configuration unit is configured to control the power amplifiers to transmit signals using frequency agile transmission.

In an embodiment a method of transmitting data over a wireless network comprises determining spectrum status information of the wireless network; harvesting energy; selecting one or more channels of the wireless network and an output power based on the spectrum status information; and transmitting data using the selected channel and the selected output power.

In an embodiment harvesting energy comprises harvesting radiofrequency and/or non-radiofrequency energy.

In an embodiment harvesting energy comprises using an antenna system and transmitting data comprises using the antenna system.

In an embodiment determining spectrum status information comprises connecting to a database using the antenna system.

In an embodiment determining spectrum status information comprises real time sensing using the antenna system.

In an embodiment the method comprises determining spectrum status information and harvesting energy in a first time slot and transmitting data in a second time slot.

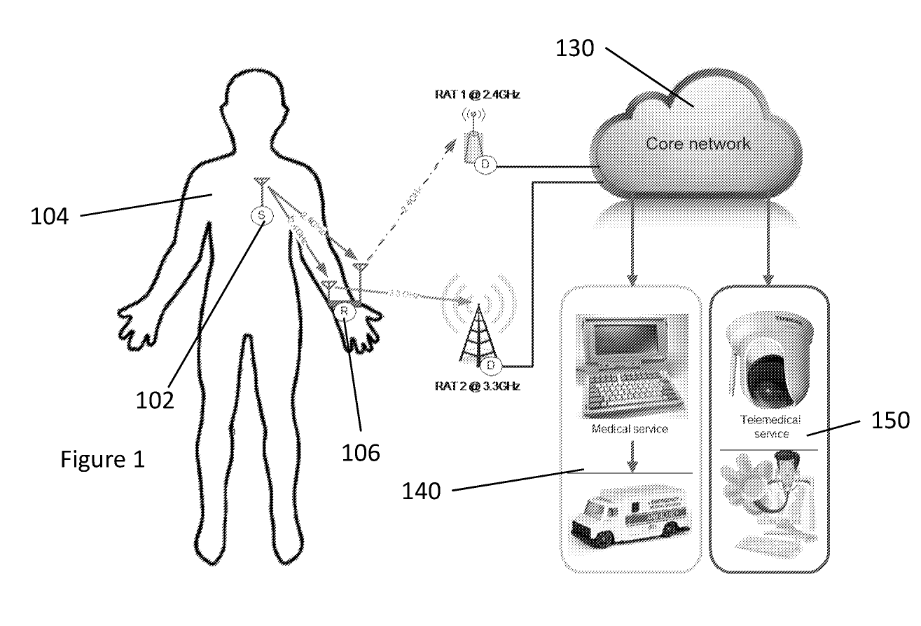

FIG. 1 shows a Medical body area network (MBAN) according to an embodiment. An implant or on-body sensor 102 is located on a patient 104. The implant or on-body sensor 102 communicates wirelessly with a relay device 106. The relay device 106 is can connect with a core network 130 using a first radio access technology RAT 1 and a second radio access technology RAT 2. The core network 130 is connected to a medical service 140 and a telemedical service 150.

The relay device 106 can harvest energy from an ambient source and/or a dedicate power source. Energy harvesting (EH) technologies offer the possibility of perpetual operation with no adverse environmental impact. By developing effective and robust communication techniques to be used under energy harvesting conditions, some communication devices and networks can be taken off the power grid with an even smaller size (considering a small-capacity battery with periodic recharging function from EH). This increases their autonomy and also decreases the overall consumption of energy and the accompanying carbon footprint in the future, by a non-negligible amount.

The relay device 106 in the MBAN is used to interconnect the implant or on-body sensor 102 with the external medical centres. This reduces the complexity and energy consumption of the sensors by letting the sensors to transmit data locally and avoid in/on-to-off body data transmission. Furthermore, relaying using different frequency channels via heterogeneous radio access technologies (RATs) can enhance the unlicensed/licensed spectrum utilization and energy efficiency, facilitated by cognitive radio (CR) technology and EH technology, which provides reliable opportunistic spectrum access services, where spectrum status (SS) information is obtained from geo-database, complemented by spectrum sensing.

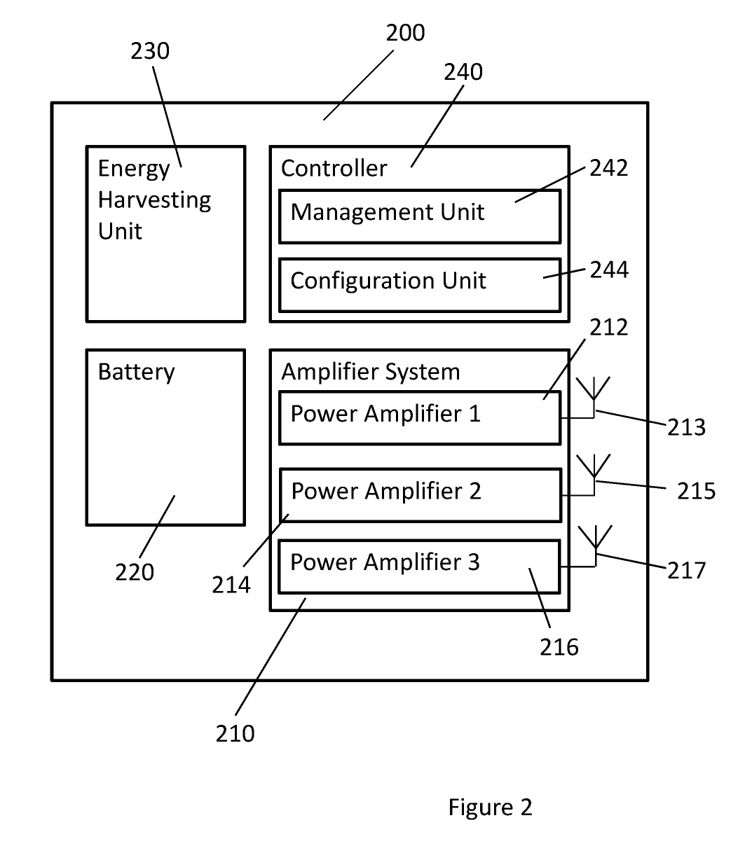

FIG. 2 shows a transmitter according to an embodiment. The transmitter 200 acts as the relay device 106 shown in FIG. 1. The transmitter 200 comprises an amplifier system 210, a battery 220, an energy harvesting unit 230 and a controller 240. In this embodiment the amplifier system 210 comprises a first power amplifier 212, a second power amplifier 214, and a third power amplifier 216. The first power amplifier 212 is coupled to a first antenna 213. The second power amplifier 214 is coupled to a second antenna 215. The third power amplifier 216 is coupled to a third antenna 217. The controller 240 comprises a management unit 242 and a configuration unit 244.

The energy harvesting unit 230 is configured to harvest energy from the environment and to use the harvested energy to recharge the battery 220. The battery 220 supplies power to the controller 240 and the amplifier system 210. In an embodiment the energy harvesting comes from radiofrequency (RF) energy. In an embodiment the RF energy harvesting unit harvests energy from ambient RF. That is to operate in a broadband mode and collect energy from multiple bands (e.g. 400 MHz up to 6 GHz). In an embodiment the RF energy harvesting unit harvest energy in a narrowband mode where energy is harvested from a dedicated or dominant source of RF energy i.e. a source that is brought in close proximity to the node in order to charge it, or a band which as part of the ambient RF energy is much higher that other sources.

In embodiments the energy harvesting unit harvests energy from source other than RF sources. For example the energy harvesting unit may harvest energy from heat or magnetic sources. In an embodiment the energy harvesting unit harvests energy from the body movement of the person to which the transmitter is attached.

The management unit 242 of the controller 240 is configured to acquire spectrum information, to control the harvesting of energy by the energy harvesting unit 230 and to control the transmission of data by the transmitter through the antennas 213 to 217. The configuration unit 244 is configured to control the configuration of the amplifiers 212 to 216 of the amplifier system 210 according to efficiently transmit data according to the spectrum information acquired by the management unit 242.

FIG. 2a shows a transmitter according to an embodiment. Elements of the transmitter 250 which are equivalent to elements of the transmitter 200 shown in FIG. 2 are labelled with the same reference numerals. The transmitter 250 comprises an amplifier system 210, a battery 220, an energy harvesting unit 230, a controller 240, and an antenna system 260. In this embodiment the energy harvesting unit 230 harvests RF energy using the antenna system 260. Further, in this embodiment the management unit 242 of the controller 240 uses the antenna system 260 to determine spectrum information. The management unit 242 may use the antenna system 260 to connect to a geo-database and download spectrum information from the geo-database. Alternatively or additionally, the management unit 242 may use the antenna system to directly sense spectrum information. The antenna system 260 is also coupled to the power amplifiers of the amplifier system 210. A switch 270 which is controlled by the management unit 242 allows the antenna system 260 to be selectively coupled to the energy harvesting unit, the management unit 242 and the power amplifiers of the power amplifier system 210.

The antenna system 260 may be implemented as a system of individual antennas, or as a single wideband antenna. If the antenna system is implemented as a wideband antenna, the switch 270 may allow switching between different radiation patterns of the antenna.

In the embodiment shown in FIG. 2a, if the antenna system 260 is used by the energy harvesting function, the spectrum acquisition function and for transmission by the power amplifier system 210, these functions must be performed at different times.

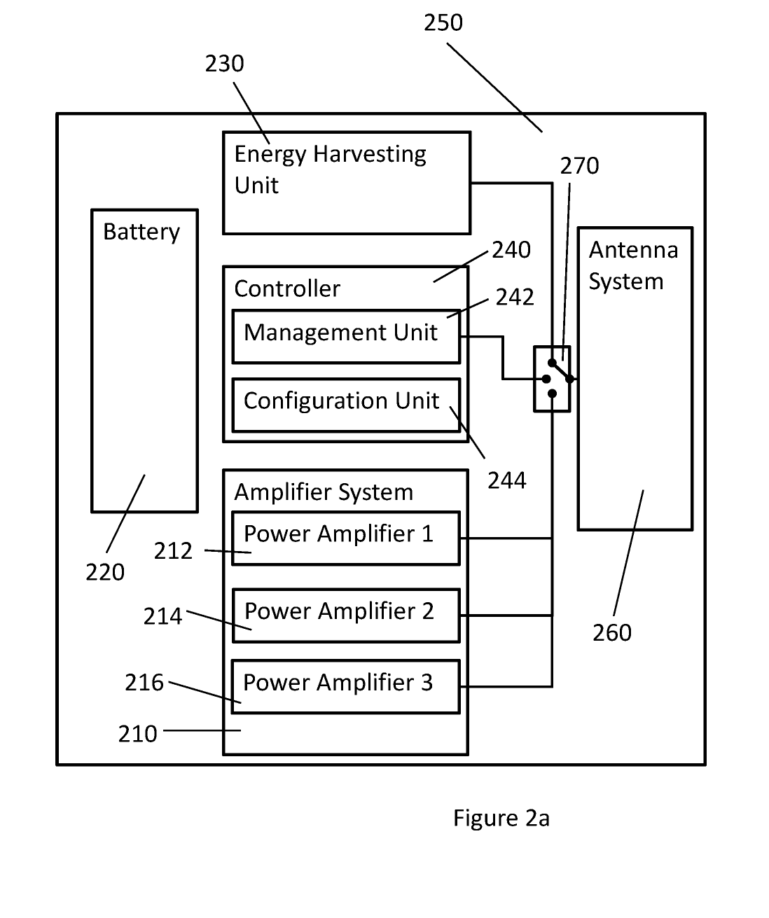

FIG. 3 is a flowchart showing a method executed by the management unit 242. In step S302, the management unit 242 acquires channel information. The management unit 242 may acquire channel information from a spectrum geo-database. Alternatively, or additionally, the management unit may acquire channel information from spectrum sensing.

In step S304, the management unit 242 controls the energy harvesting unit 230 to harvest energy from the environment.

In step S306, the management unit 242 optimises the amplifier system 210 to transmit data. The optimisation takes into account the channel information acquired in step S302. The optimisation involves the configuration unit 244 setting an optimum configuration for one or more of the power amplifiers of the amplifier system 210. For example, the configuration unit 244 may set a supply voltage to for one of the amplifiers.

In step S308, data is transmitted from one or more of the antennas according to the optimised configuration.

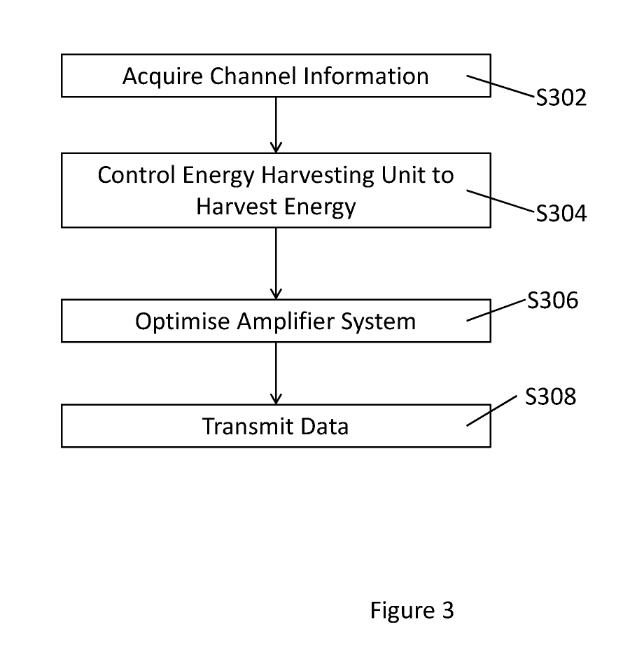

FIG. 4 shows a transmitter according to an embodiment. The transmitter 400 has an amplifier system which comprises a first narrow band power amplifier (NBPA) 412, a second NBPA 414 and a wide band power amplifier (WBPA) 416. The first NBPA 412 is coupled to a first antenna 413, the second NBPA 414 is coupled to a second antenna 415 and the WBPA is coupled to a third antenna 417. The antennas operate in different channels of heterogeneous networks (HetNets).

The power amplifier system is controlled by a controller 440. The controller 440 comprises an Energy, Spectrum & PA (E-SPA) management unit 442 and a Power Amplifier supply configuration (PA-SC) unit 444. In this embodiment the Energy, Spectrum & PA (E-SPA) management unit 442 performs the functions of the management unit 242 shown in FIGS. 2 and 2a and the Power Amplifier supply configuration (PA-SC) unit 444 performs the functions of the configuration unit 244 shown in FIGS. 2 and 2a.

The Power Amplifier supply configuration unit 444 comprises a first voltage selector 445 which selects a supply voltage for the WBPA 416 from a plurality of voltages Vₛ, V₁, . . . Vₙ. The Power Amplifier supply configuration unit 444 further comprises a second voltage selector 446 which selects a supply voltage for the first NBPA 412 a plurality of voltages Vₛ, V₁, . . . Vₙ, and a third voltage selector 447 which selects a supply voltage for the second NBPA 414 a plurality of voltages Vₛ, V₁, . . . Vₙ.

A single pole double throw (SPDT) radiofrequency switch 460 controlled by the Energy, Spectrum & PA management unit 442 is configured to select between the power amplifiers. The radiofrequency switch 460 controls which of the power amplifiers data 465 to be transmitted is supplied to.

The transmitter 400 is powered by a rechargeable battery 420. The rechargeable battery 420 is coupled to an Energy harvesting and transfer (EH) unit 430. The energy harvesting and transfer unit 430 is controlled by the Energy, Spectrum & PA management unit 442. The battery 420 corresponds to the battery 220 shown in FIGS. 2 and 2a and the Energy harvesting and transfer unit 430 corresponds to the energy harvesting unit 230 shown in FIGS. 2 and 2a. As discussed above in relation to FIG. 2a, the energy harvesting and transfer unit 430 may harvest energy from RF sources. If this is the case, then the antennas 413, 415 and 417 may be used for the energy harvesting function in addition to the transmission function.

The Energy, Spectrum & PA management unit 442 is connected to a Spectrum geo-database 450 containing geographical spectrum status information from third parties such as FCC or OFCOM. By connecting to the Spectrum geo-database 450 the Energy, Spectrum & PA management unit 442 determines spectrum status information. The Spectrum geo-database 450 is external to the transmitter 400. The Energy, Spectrum & PA management unit 442 is also connected to a node 455 which fuses the sensing results from the antennas and send it to E-SPA unit 442. In an embodiment the node 455 is embedded in E-SPA unit 442.

The transmitter 400 employs periodic transmission mechanism. As discussed above in relation to FIG. 2a, in an embodiment the transmitter 400 uses the antennas 413, 415 and 417 to determine spectrum information, to harvest energy and to transmit data. The antennas 413, 415 and 417 may be implemented as separate antennas, or as a single wideband antenna with a configurable driving pattern.

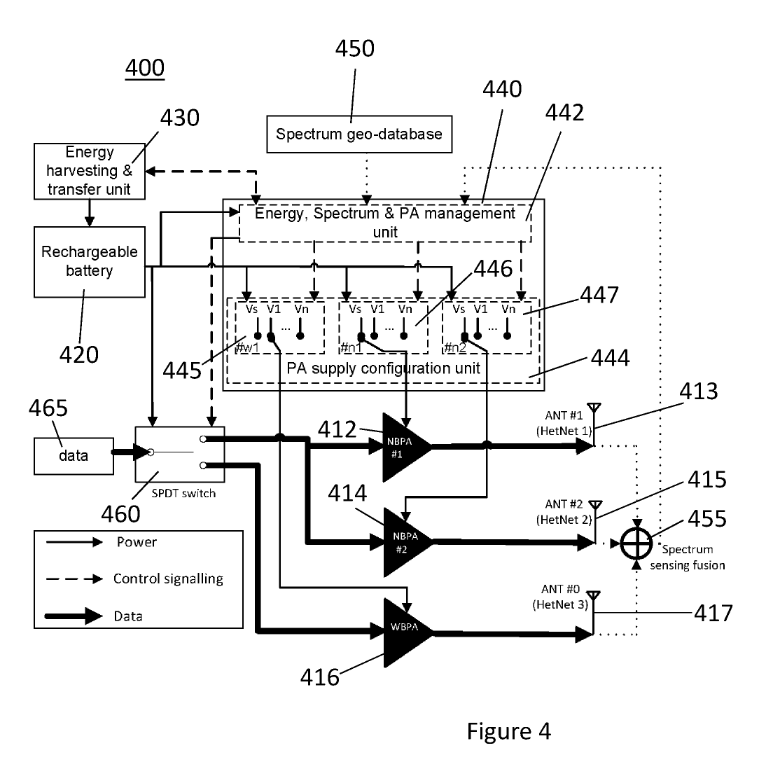

FIG. 5 is a timing diagram showing one-packet transmission including spectrum information acquisition; energy harvesting & transfer; data transmission at different transmit power levels in different channels/HetNets.

As shown in FIG. 5, each packet consists of several frames. Each frame consists of an environment slot (E-slot) and a data transmission slot (D-slot). Spectrum status information is obtained and energy harvesting is performed in the E-slot. Based on the spectrum status and energy status from the E-slot, the system will determine whether to start/continue data transmission in a D-slot or to suspend the data transmission.

In an embodiment the relay device (the transmitter 200 shown in FIG. 2, the transmitter 250 shown in FIG. 2a or the transmitter 400 shown in FIG. 4) operates as a Secondary User (SU) in a Cognitive network. The SU is opportunistically using bandwidth licenced to a Primary User (PU).

In the embodiment shown in FIG. 5, a packet of data is transmitted using two channels: HetNet 1: Channel 1 and HetNet 2: Channel 2. The packet comprises 5 Frames. Each frame comprises an E-Slot and a D-slot. In the E-Slot, spectrum information is obtained, and energy harvesting takes place. The time duration of the energy harvesting process may depend on how fast the system can obtain the spectrum information, how much spectrum information we need, and what's the status of the battery. If the battery level is low, then the energy harvesting may take place before the acquisition of the spectrum information. If the battery level high (for example above a threshold) then the spectrum may be obtained first.

In the E-Slot 502 of Frame 1 of channel 1, the channel status updates from the geo-database or sensing indicate that the channel is idle. In the D-Slot 504 of Frame 1 of channel 1, data transmission starts at low power. During the D-Slot 504, a primary user (PU) begins transmitting on the channel. This causes a collision as the transmission form the primary user interferes with the transmission from the relay device.

The collision may not be detected by the relay device until the next E-Slot since the geo-database is not consulted during the D-Slot. As shown in FIG. 5, in the next D-Slot 508 the channel status update indicates that the channel is busy. The relay device may be configured to retransmit the data from a D-Slot in which a collision occurs.

In the E-Slot of Frame 2 of channel 1, energy harvesting 510 takes place after the channel status updates have been received. In the D-Slot 512 of Frame 2 transmission is suspended.

In the E-Slot 514 of Frame 3 of channel 1, the channel status update indicates that the channel is idle. Following the channel status update, energy harvesting 516 takes place. In the D-Slot 518 of frame 3, data is transmitted at high power.

In the E-Slot 520 of Frame 4 of Channel 1, the channel status update indicates that the channel is idle. In the D-Slot 522 of frame 4, data is transmitted at high power.

In the E-Slot 524 of frame 5 of channel 1, the channel status update indicates that the channel is idle. Following the channel status update, energy harvesting 526 takes place.

In the D-Slot 528 of Frame 5 of channel 1, data is transmitted at lower power. As shown in FIG. 5, a collision takes place in the D-Slot 528 of frame 5.

The transmission of data in channel 2 follows a similar sequence to channel 1. As shown in FIG. 5, during certain periods, for example Frame 1, channel 1 is idle and can be used by the relay device but channel 2 is busy and cannot be used by the relay device.

While FIG. 5 has been described above in relation to a cognitive network, those of skill in the art will appreciate that the above description is also applicable to any interference limited system in which the primary user discussed in relation to FIG. 5 acts as an interference source.

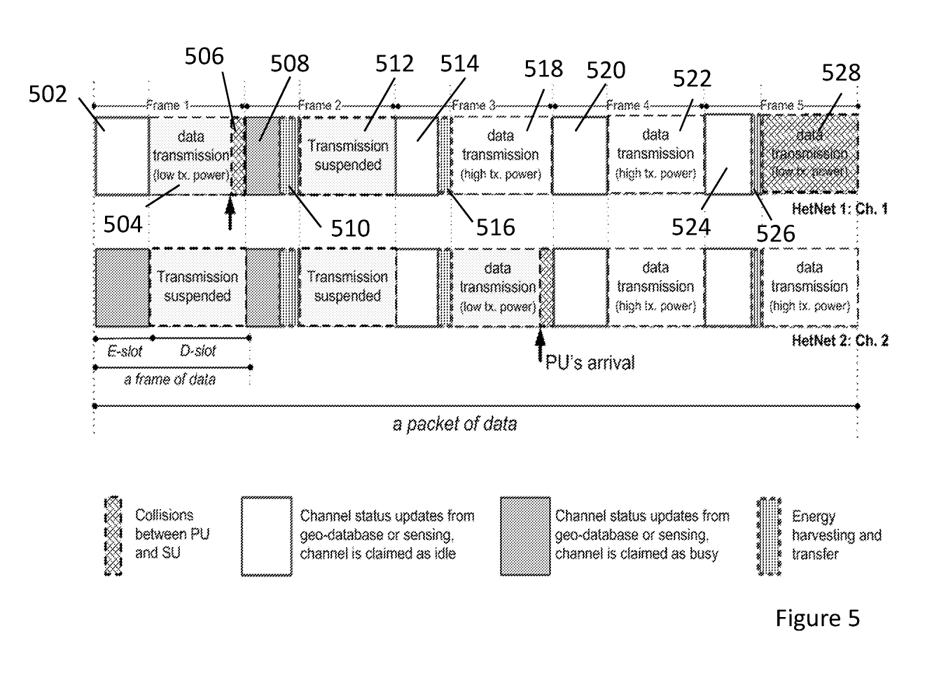

FIG. 6 is a flowchart showing the operational processes of the proposed system in an embodiment.

The E-SPA 442 unit periodically acquires the channel status information from the spectrum geo-database. If the connection to the database is not available, spectrum sensing may be deployed as an alternative method, energy will be harvested by the EH unit 430 within the E-slot if the channel information acquisition process does not occupy the entire E-slot.

Furthermore, spectrum information can be acquired from geo-database in a scalable method. In particular, if the current acquisition link is good and the device is moving, it is beneficial to download not only spectrum information of the current cell but that of neighbouring cells. On the other hand, energy harvesting will be performed first in E-slot if the connection to the database is not available or the battery level is too low for data transmission.

In step S602 a check is made whether one packet of data has been transmitted. If the transmission of one packet has been completed, the method ends. Otherwise, the method moves to step S604. In step S604, the energy stored in the rechargeable battery is compared with a threshold. If the stored energy is below the threshold, the method moves to step S606. If the energy stored in the rechargeable battery is above the threshold the method moves to step S612.

In step S606, energy harvesting and transfer takes place. Following step S606, the method moves to step S608. In step S608 it is checked whether the end of an E-slot has been reached. If the end of an E-slot has been reached, the method moves to step S610. In step S610, data transmission in the following D-slot is suspended and energy harvesting may be continued in the D-slot if required. If the end of an E-slot has not been reached, the method moves to step S612.

In step S612 a check is made whether the device is in motion. If the device is in motion, the method moves to step S618. If the device is not in motion, the method moves to step S614.

In step S614 spectrum status information is acquired for the current cell in which the device is located and the method moves to step S616. In step S616, it is checked whether the acquisition of spectrum status information for the current cell was successful. If the acquisition of spectrum status information for the current cell was successful the method moves to step S630. If the acquisition of spectrum status information for the current cell was unsuccessful the method moves to step S624 in which S608 it is checked whether the end of an E-slot has been reached. If the end of an E-slot has been reached, the method moves to step S610. If the end of an E-slot has not been reached the method moves to step S606 in which energy harvesting takes place.

In step S618 a check is carried out on the communication link to the spectrum geo-database. If the communication link is good, the method moves to step S620. If the communication link is not good, the method moves to step S614.

In step S620 information on the spectrum status of the current cell and neighbouring cells is acquired. In step S622 it is determined if the acquisition of spectrum information for the current cell and neighbouring cells was successful. If the acquisition of spectrum information for the current cell and neighbouring cells was successful then the method moves to step S630. If the acquisition of spectrum information for the current cell and neighbouring cells was not successful then the method moves to step S616.

The configuration of the power amplifiers starts in step S630. In step S630 it is determined whether the operation bandwidth can be covered by the narrow band power amplifiers.

If the operation bandwidth can be covered by the narrow band power amplifiers then a check is made in step S632 whether the operation bandwidth can be covered by a single narrow band power amplifier. If the operation bandwidth can be covered by a single narrow band power amplifier then that narrow band power amplifier is optimised for the selected output power in step S634 and the method moves to step S650. If the operation bandwidth cannot be covered by a single narrow band power amplifier then two or more narrow band power amplifiers are selected and aggregated in step S636. In step S636 the centre frequencies of the selected narrow band power amplifiers are shifted and the aggregated output power of the selected narrow band power amplifiers is configured. The method then moves to step S650.

If the operation bandwidth cannot be covered by the narrow band power amplifiers then then method moves to step S640 in which the wide band power amplifier is selected. In step S642, the wide band power amplifier configuration is optimised for the selected output power and the method then moves to step S650.

In step S650 data is transmitted using the optimised power amplifier configuration selected in the previous steps.

In an embodiment, the spectrum information may be downloaded from the geo-database in a scalable manner.

In the embodiment described above in relation to FIG. 4 the configuration unit controls the supply voltage of the power amplifiers. In embodiments the PA-SC unit, controlled by the E-SPA unit, is employed to reconfigure the output power of PA and/or the frequency shifting operation by solely or jointly using the following methods
a discrete or continuous supply voltage selection/modulation technology
or bias voltage control technology,
or load-modulation or load selection control technology,
or joint PAs output power aggregation and frequency agile transmission.

These methods, as illustrated in FIG. 6, control the PA(s) over a large dynamic range of output power at high efficiency, instructed by E-SPA unit. This is particularly useful to tackle a high Peak-to-Average Power Ratio (PAPR) OFDM modulated signal or similar high PAPR schemes. This also helps to reduce the complexity of the PA design if the receiver (e.g., base station) uses Massive MIMO technology. In addition, the PA supply configuration unit is capable to jointly operate PA in aggregating/reconfiguring the output power level and shifting the central frequency of PAs in HetNets.

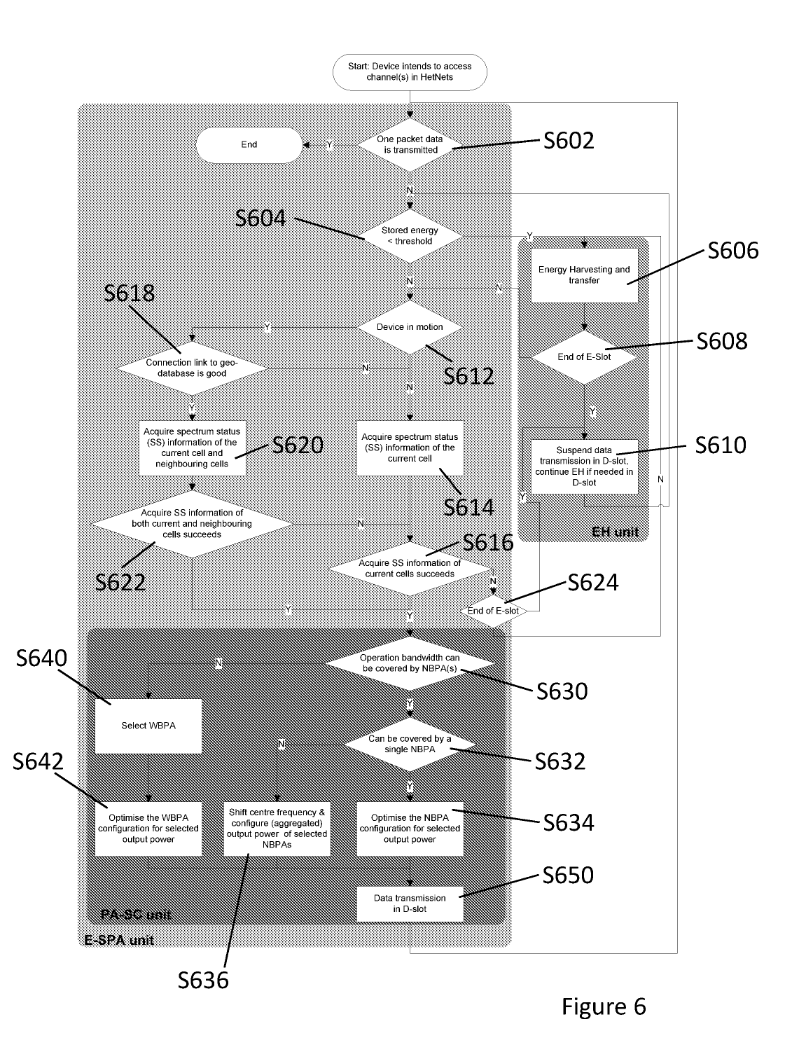

FIG. 7a shows the control of the amplifier configuration using load modulation in an embodiment. A power amplifier 722 is coupled to a tuneable matching network 724. The configuration unit of the controller outputs a load control signal which sets an impedance of the tuneable matching network 724.

FIG. 7b shows the control of the amplifier configuration using load selection in an embodiment. A switch 744 selects a load to be coupled to a power amplifier 742 from a plurality of possible loads 746 747 748.

The switch 744 may be able to select the suitable power amplifier and modulate its output power for a sleeping or inactive mode, a low power transmission mode and a high power transmission mode. This selection may be used to select the appropriate power amplifier in addition to selecting the output power for that amplifier by switching the remaining power amplifiers into an inactive or sleep mode.

FIG. 7c shows the control of the amplifier configuration using supply voltage selection in an embodiment. In this embodiment the supply voltage of a power amplifier 762 is controlled by a supply selector 764 which acts as the configuration unit.

The supply selector may be configured to select an appropriate voltage from a voltage bank comprising a voltage level for a sleeping or inactive mode, a voltage level for low transmission power and a voltage level for high transmission power. This selection may be used to select the appropriate power amplifier in addition to selecting the output power for that amplifier by switching the remaining power amplifiers into an inactive or sleep mode.

FIG. 7d shows the control of the amplifier configuration using output power aggregation and frequency agile transmission in an embodiment. A first power amplifier 782 and a second power amplifier 784 are connected to an RF combiner/router 786 which can selectively connect the first power amplifier 782 and the second power amplifier 784 to a first antenna 787 and a second antenna 788. The first antenna 787 is arranged to transmit signals of a first frequency f1 and the second antenna 788 is arranged to transmit signals of a second frequency f2. The RF combiner/router 786 is controlled by a mode control signal. FIG. 7d shows the output of the system in different modes. In Mode 1 both the first power amplifier 782 and the second power amplifier 784 are coupled to the first antenna 787 so the output is a signal of the first frequency having the combined output power of the first power amplifier 782 and the second power amplifier 784. In Mode 2 the first power amplifier 782 is coupled to the first antenna 787 and the second power amplifier 784 is coupled to the second antenna 788 so the output is a signal having both the first frequency f1 and the second frequency f2. In Mode 3 both the first power amplifier 782 and the second power amplifier 784 are coupled to the second antenna 788 so the output is a signal of the second frequency f2 having the combined output power of the first power amplifier 782 and the second power amplifier 784.

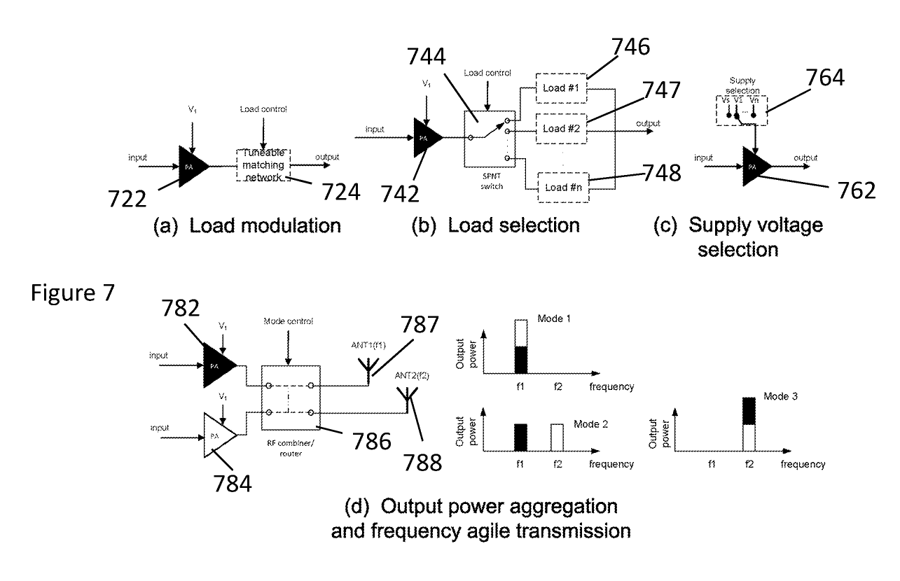

Measurement results are given here to demonstrate the performance of embodiments as discussed above, embodiments include the process of acquiring channel access knowledge, acquiring energy from nature and using these to drive an optimisation procedure in the RF subsystem for high energy efficiency. FIGS. 8 to 10 show the efficiency of the PA as a function of the PA output power using different methods employed by PA-SC, and driven by E-SPA unit.

FIG. 8 shows the efficiency of the power amplifier as a function of output power using load modulation in the PA-SC unit.

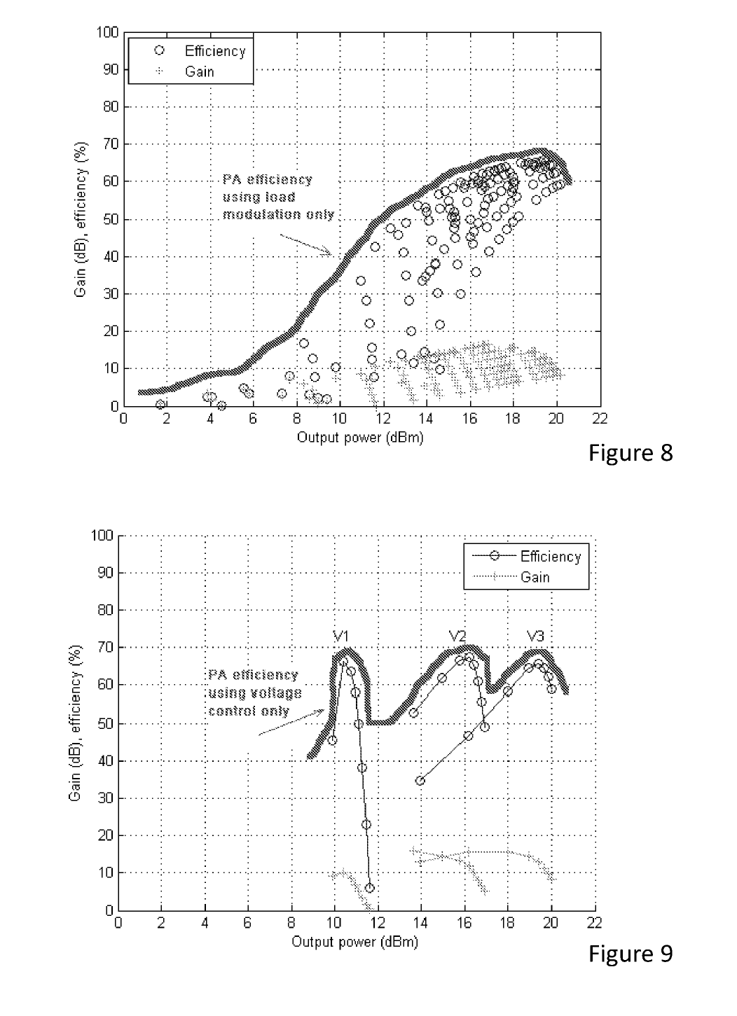

FIG. 9 shows the efficiency performance using supply voltage selection in the PA-SC unit.

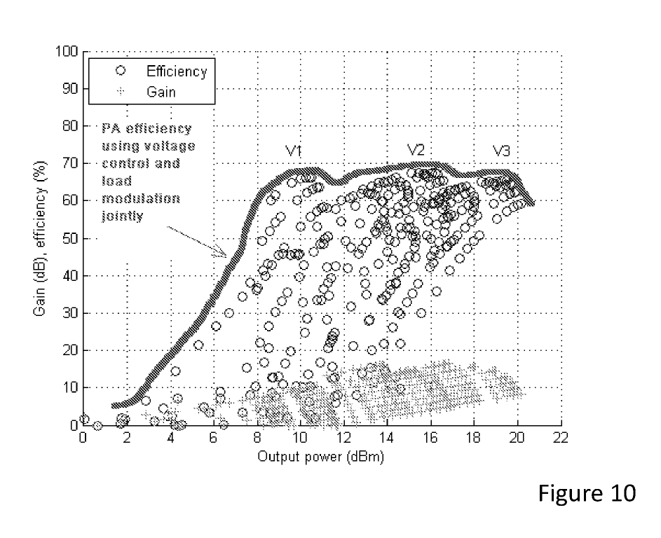

FIG. 10 shows the efficiency performance using the combination of load modulation and supply voltage selection methods in the PA-SC unit.

FIGS. 8 to 10 above show that the efficiency can be improved by using the methods provided by PA-SC unit and being driven by E-SPA unit. Individually load modulation or supply voltage selection can only provide high efficiency at certain output power points with lower efficiency between these points. However, combining load modulation and supply voltage selection methods can provide high efficiency even when different output power levels are required.

Embodiments include a system for any battery-powered device in heterogeneous networks using licensed/unlicensed bands. By employing periodic transmission mechanism, a system with periodic spectrum status acquisition and periodic energy harvesting functions is proposed to drive a PA set supporting different PA output power on different frequency channels of heterogeneous networks with high energy efficiency.

In the embodiment described in relation to FIG. 1 an example is given in a scenario of body area relaying networks for healthcare applications where the proposed system with its Energy, Spectrum & PA (E-SPA) management unit is used in a relay node.

The proposed system can also be applied in other scenarios. Such as in a relaying/base station for cellular networks, smart/cognitive networks or in other multiple radio access technology (RAT) networks.

The specific embodiments are presented schematically. The reader will appreciate that the detailed implementation of each embodiment can be achieved in a number of ways. For instance, a dedicated hardware implementation could be designed and built. On the other hand, a processor could be configured with a computer program, such as delivered either by way of a storage medium (e.g. a magnetic, optical or solid state memory based device) or by way of a computer receivable signal (e.g. a download of a full program or a “patch” update to an existing program) to implement the management unit described above in relation to the embodiments. Besides these two positions, a multi-function hardware device, such as a DSP, a FPGA or the like, could be configured by configuration instructions.

Whilst certain embodiments have been described, these embodiments have been presented by way of example only, and are not intended to limit the scope of the inventions. Indeed, the novel devices, and methods described herein may be embodied in a variety of other forms; furthermore, various omissions, substitutions and changes in the form of the devices, methods and products described herein may be made without departing from the spirit of the inventions. The accompanying claims and their equivalents are intended to cover such forms or modifications as would fall within the scope and spirit of the inventions.

1. A wireless device comprising:
a plurality of power amplifiers operable to generate signals for transmission over different frequency channels of a wireless network;
an antenna system coupled to the plurality of power amplifiers configured to transmit the signals generated by the power amplifiers;
a battery configured to store energy and to supply electrical energy to the plurality of power amplifiers;
an energy harvesting unit configured to harvest energy from the environment surrounding the wireless device and transfer the harvested energy to the battery;
a management unit configured to determine spectrum status information of the wireless network, select one or more channels of the wireless network, and determine the output power of the power amplifiers; and
a configuration unit configured to control the efficiency and output power of each of the power amplifiers.

2. A wireless device according to claim 1, wherein the energy harvesting unit is configured to harvest radiofrequency energy using the antenna system and/or other non-radiofrequency energy.

3. A wireless device according to claim 2, wherein the management unit is configured to determine the spectrum status information using the antenna system.

4. A wireless device according to claim 3, wherein the management unit is configured to obtain the spectrum status information by connecting to a database using the antenna system.

5. A wireless device according to claim 3, wherein the management unit is configured to obtain the spectrum status information by real time sensing using the antenna system.

6. A wireless device according to claim 4, wherein the management unit is configured to determine spectrum status information conduct energy harvesting within a first time slot and to configure the configuration unit to control transmission of data within a second time slot.

7. A wireless device according to claim 1, wherein the configuration unit is configured to control the power amplifier system to transmit a packet of data over a plurality of frames, each frame comprising a first time slot and a second time slot.

8. A wireless device according to claim 4, wherein the management unit is configured determine if the device is moving and to download spectrum status information for a plurality of cells of the wireless network if the device is moving.

9. A wireless device according to claim 1, wherein the configuration unit is configured to control the output power of the power amplifiers by controlling a supply voltage to the power amplifiers.

10. A wireless device according to claim 9, wherein the configuration unit is configured to select the supply voltage from a voltage level for an inactive mode, a voltage level for a low power transmission mode and a voltage level for a high power transmission mode.

11. A wireless device according to claim 1, wherein the configuration unit is configured to control a load of the power amplifiers.

12. A wireless device according to claim 1, wherein the configuration unit is configured to select the load for the power amplifiers from a load bank depending on the output power level required.

13. A wireless device according to claim 1, wherein the configuration unit is configured to control the power amplifiers and RF combiner/router to aggregate the output power of at least two of the power amplifiers.

14. A wireless device according to claim 1, wherein the configuration unit is configured to control the power amplifiers to transmit signals using frequency agile transmission.

15. A method of transmitting data over a wireless network, the method comprising:
determining spectrum status information of the wireless network;
harvesting energy;
selecting one or more channels of the wireless network and an output power based on the spectrum status information; and
transmitting data using the selected channel and the selected output power.

16. A method according to claim 15, wherein harvesting energy comprises harvesting radiofrequency and/or non-radiofrequency energy.

17. A method according to claim 16, wherein harvesting energy comprises using an antenna system and transmitting data comprises using the antenna system.

18. A method according to claim 17 wherein determining spectrum status information comprises connecting to a database using the antenna system.

19. A method according to claim 17 wherein determining spectrum status information comprises real time sensing using the antenna system.

20. A method according to claim 15, comprising determining spectrum status information and harvesting energy in a first time slot and transmitting data in a second time slot.
